(19) United States
(12) Patent Application Publication
(10) Pub. No.: US 2010/0325615 A1
(43) Pub. Date: Dec. 23, 2010

(54) METHOD AND SYSTEM FOR CAPTURING WEB-PAGE INFORMATION THROUGH WEB-BROWSER PLUGIN

(75) Inventor: Yadid Ramot, Santa Monica, CA (US)

Correspondence Address: Cantor Colburn LLP - Fox Entertainment Group, 20 Church Street, 22nd Floor, Hartford, CT, 06103, US

(73) Assignee: MYSPACE INC., Beverly Hills, CA (US)

(21) Appl. No.: 12/822,174

(22) Filed: Jun. 23, 2010

Related U.S. Application Data
(60) Provisional application No. 61/219,489, filed on Jun. 23, 2009.

(51) Int. Cl. G06F 15/173; G06F 9/44

(52) U.S. Cl. 717/124; 709/224

(57) ABSTRACT

Capturing web-page information through a web-browser plug-in includes accessing a target test website, receiving webpage data from the target test website, injecting test code into the webpage data to create a modified webpage, executing the injected test code from the modified webpage, and outputting results of the executing.

### CROSS REFERENCE TO RELATED PATENT APPLICATIONS

This application claims benefit under 35 U.S.C. §119 to Provisional Application Ser. No. 61/219,489, entitled “METHOD AND SYSTEM FOR CAPTURING WEB-PAGE INFORMATION THROUGH WEB-BROWSER PLUGIN,” filed on Jun. 23, 2009, the entire contents of which are hereby incorporated by reference.

### TECHNICAL FIELD

The present invention is generally related to web browsers and the Internet. More particularly, example embodiments of the present invention are related to methods and systems for capturing web-page information through a web-browser plug-in/third-party application module.

### BACKGROUND OF THE INVENTION

Conventionally, content on web pages viewed through a browser includes various media and feature rich material. For example, many web pages include advertisements, photographs, banners, and other similar material. Some of this material may be comprehensive and processing time to accurately display this material may hinder access to a web-page. Typically, web page debugging and other tailoring is a tedious process including manipulation of source code and much trial and error in order to understand a webpage's behaviors. It follows that as the content of a webpage increases in functionality, tuning the performance of the webpage, at least as seen on a client machine accessing the webpage, becomes increasingly difficult.

### SUMMARY

According to an example embodiment of the present invention, a system for capturing web-page information through a web-browser plug-in includes a data warehouse, a client machine in communication with the data warehouse, and a proxy server in communication with the client machine. The proxy server is configured to perform a method including accessing a target test website, receiving webpage data from the target website, injecting test code into the webpage data to create a modified webpage, and passing the modified webpage to the client machine. The client machine is configured to perform a method including executing the injected test code from the modified webpage, and outputting results of the executing.

According to an example embodiment of the present invention, a computer-implemented method of capturing web-page information through a web-browser plug-in. The method includes accessing a target test website, receiving webpage data from the target test website, injecting test code into the webpage data to create a modified webpage, executing the injected test code from the modified webpage, and outputting results of the executing.

According to an example embodiment of the present invention, a computer program product for capturing web-page information through a web-browser plug-in, comprising a tangible storage medium readable by a processing circuit and storing instructions for execution by the processing circuit for performing a method. The method includes accessing a target test website, receiving webpage data from the target test website, injecting test code into the webpage data to create a modified webpage, executing the injected test code from the modified webpage, and outputting results of the executing.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The figures:

FIG. 1 depicts a diagram representing the arrangement of an example system, according to example embodiments;

FIG. 2 depicts a diagram representing an example client plug-in architecture, according to example embodiments;

FIG. 3 depicts a diagram representing an example client plug-in architecture, according to example embodiments;

FIG. 4 depicts a method of capturing web-page information through a web-browser plug-in, according to example embodiments;

FIG. 5 depicts an example computer apparatus, according to example embodiments; and

FIG. 6 depicts a computer program product, according to example embodiments.

### DETAILED DESCRIPTION

Further to the brief description provided above and associated textual detail of each of the figures, the following description provides additional details of example embodiments of the present invention.

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments of the present invention will be described in detail.

According to example embodiments, a browser plug-in is provided which significantly enhances a user or developer's ability to debug or troubleshoot a web-page through extraction of web-page statistics relatively easily compared to conventional means. As example embodiments provide a browser plug-in, it is appreciated that additional applications are not necessary on a web-page server, as the plug-in is installed on a client side accessing a web-page only. Therefore, example embodiments provide a complete profiling solution which can track and record page delivery times, rendering times, and a full client's machine performance monitoring through the use of the standalone browser plug-in. The browser plug-in may be user-configurable to test and extract statistics from any web-page on an as-needed basis, or time-scheduling characteristics may be selected such that testing/extraction is completed on a scheduled basis.

As used herein, a plug-in may be a set of software components that add specific capabilities to a larger software application(s). Plug-ins enable customizing the functionality of an application. For example, plug-ins are commonly used in web browsers to play video, scan for viruses, and display new file types. Add-on is a general term comprising snap-ins, plug-ins, extensions, and themes. It should be understood that any of these terms may be used interchangeably herein.

According to example embodiments, the browser plug-in may gather, analyze, and/or record rendering times for HTML (Hypertext Mark-up Language) portions of a webpage, real-time screen captures of HTML portions and repaint events, complete CPU (Central Processing Unit) and memory (RAM, ROM, VirtualMem, etc.) monitoring on client computer side, download order of portions of a web-page, coding guidelines/rules validation for a web-page, and/or compression rates for portions of the web-page (e.g., pictures, video, etc). It should be understood that the above is not an exhaustive listing and other characteristics/statistics of a web-page are easily implemented through example embodiments. As such, any suitable or desired information may also be monitored, recorded, and/or analyzed through the browser plug-in.

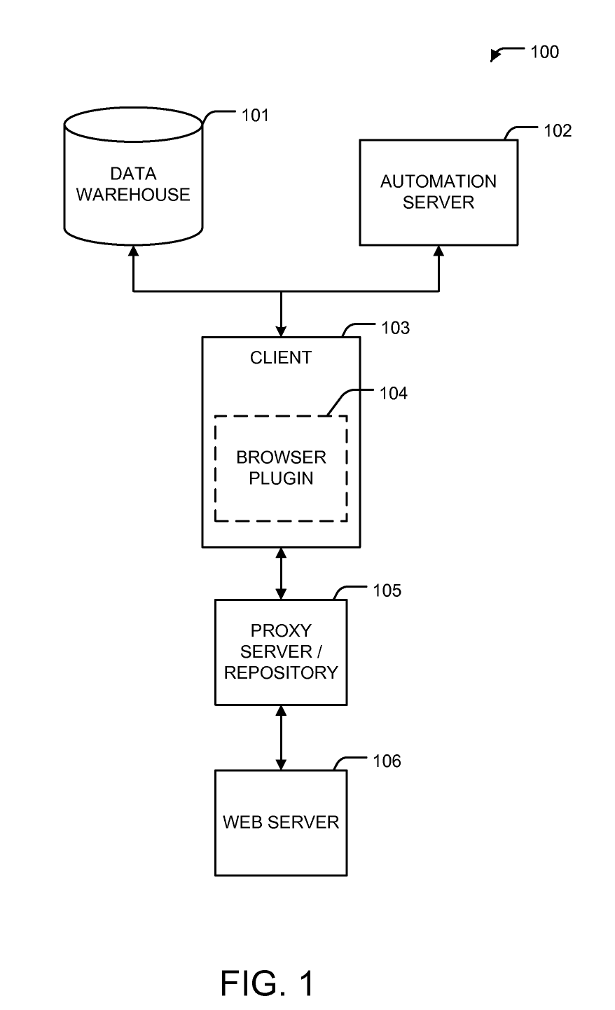

Turning to FIG. 1, a profiling system 100 configured to capture web-page information through a web-browser plug-in is illustrated. The system 100 may include a data warehouse 101 and an automation server 102, both in communication with a client 103.

The data warehouse 101 may be a web-server configured and disposed to host gathered information. For example, the data warehouse 101 may host, store, distribute, or make accessible, information gathered from a plurality of web-pages, servers, clients, or other suitable sources.

The automation server 102 may be a server configured and disposed to supply and execute automation methodologies. For example, the automation methodologies may be in the form of computer executable code, code portions, and/or scripts. The computer executable code may constitute an application or a portion of an application configured to store automation scripts related to testing and gathering information as described herein. The testing code portions may be injected to facilitate testing algorithms, and may include render timing test code, screen grabbing test code, CPU and memory test code, forwarding code (e.g., to forward a user/tester to a next web-page to be tested), test results submission test code, and/or any suitable code. These automation methodologies are made available to the client machine 103 such that the client machine may use the methodologies to test a desired target webpage.

Render timing test code may be configured to test the rendering time of a web-page's elements. Screen grabbing test code may be configured to take or acquire web-browser screen shots at any page-load interval (e.g., during any phase of web-page rendering on a client browser). The CPU and memory test code may be configured to perform CPU and memory monitoring of the client machine 103 (i.e., machine including the web-browser and browser plug-in). The forwarding test code includes code portions to forward a user/developer/tester to a next web-page desired to be tested.

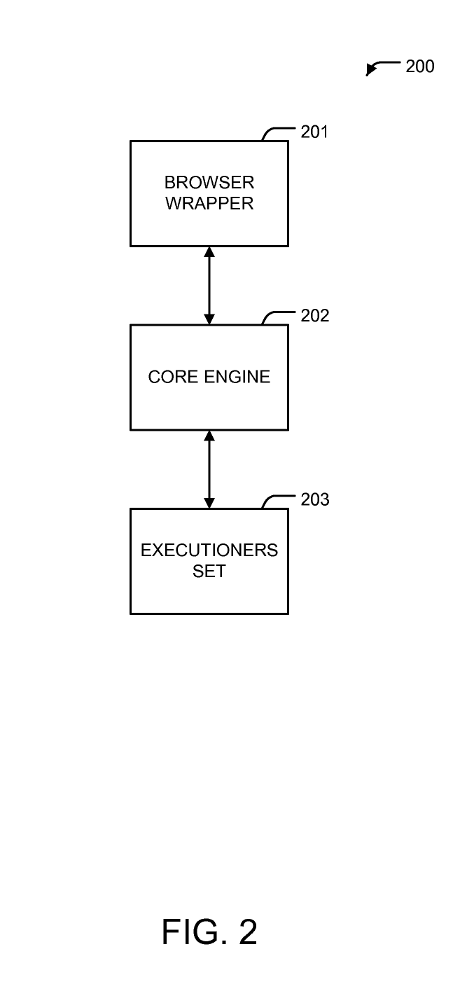

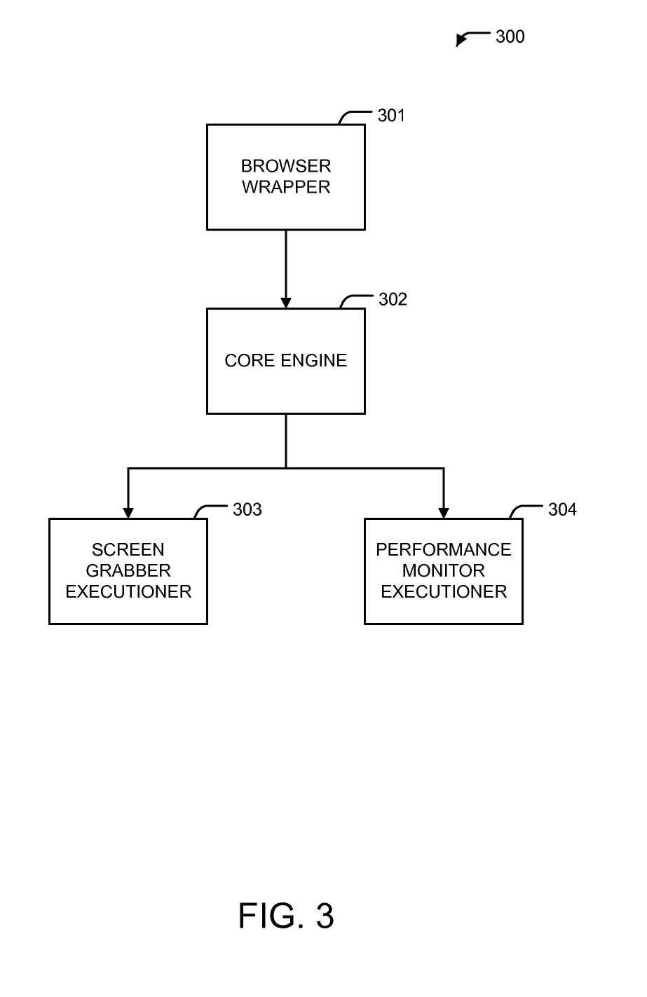

The client 103 may be a computer apparatus disposed and configured to perform testing operations through the use of the methodologies described herein. The client 103 may include a browser plug-in 104. The browser plug-in 104 is a client-side (browsing computer) plug-in (see FIGS. 2-3) disposed and configured to handle application (e.g., Javascript™) events and perform browser tracking. The browser plug-in may include a core engine, an executioner set (e.g., a Javascript™ executioner set), and a web-browser implementation. The core engine is an abstracted implementation of core functionality of the profiling system described above. The Javascript™ executioners set is a set of plug-ins/tools to communicate with Javascript™ code portions, and the web-browser implementation is a web wrapper for the browser plug-in's core engine.

The system 100 may further include a proxy server/repository 105 in communication with the client 103. The proxy server/repository 105 may be a repository of scripting portions configured and disposed to perform actual web-page tests and submissions. The proxy server/repository 105 is configured to inject test code portions into a web-page to be tested. The proxy server/repository is further configured and capable of complete control to transform and modify incoming and outgoing data. The proxy server/repository 105 may be a modular server configurable and supporting multiple simultaneous connections. According to example embodiments, the proxy server/repository 105 may trace connection speed and download order for a web-page, modify request/response headers, parse chunked or “zipped” data, buffer server-responded data, throttle HTTP (Hypertext Transfer Protocol) connections, and inject java script or testing code portions into a web-page to be tested. According to at least one example embodiment, the proxy server/repository 105 is a Javascript™ repository.

The system 100 further includes a web server 106 in communication with the proxy server/repository 105. The web server may be any capable server apparatus, configured to server webpage information, and may be a target web server serving a URL for a target test site. For example, the web server may include a web page desired to be tested using example embodiments.

Although not explicitly illustrated, it should be understood that all communication between elements of the system 100 may be facilitated through any suitable communications medium, including, but not limited to, a network, a wired connection, a wireless network, the Internet, or any suitable communications medium or combination of mediums. Exhaustive description of every possible communications configuration is omitted herein for the sake of brevity.

Turning to FIG. 2, a more detailed description of an example browser plug-in is illustrated.

FIG. 2 depicts a diagram representing an example client plug-in architecture 200 according to example embodiments. As illustrated, the browser plug-in architecture 200 may include a core engine 202, an executioner set 203 (e.g., a Javascript™ executioner set) in communication with the core engine 202, and a web-browser implementation, or wrapper, 201 in communication with the core engine 202.

The core engine 202 may be an abstracted implementation of core functionality of the profiling system described above. The executioners set 203 is a set of plug-ins/tools to communicate with application code portions (e.g., Javascript™ code portions), and the web-browser implementation 201 is a web wrapper for the browser plug-in's core engine.

FIG. 3 depicts a diagram representing an example client plug-in architecture according to example embodiments. The architecture 300 may be somewhat similar to the architecture 200. For example, the architecture 300 may include a browser wrapper 301 in communication with a core engine 302. The browser wrapper 301 and the core engine 302 may be similar to the browser wrapper 201 and the core engine 202, therefore exhaustive description is omitted herein for the sake of brevity.

The architecture 300 further includes a set of executioners 303-304.

As illustrated, example executioners may include a screen grabber executioner 303 and a performance monitor executioner 304. The screen grabber executioner 303 may acquire/take a screen shot of a web-page and store the acquired data on the client machine. The performance monitor executioner 304 is configured to perform client-side performance monitoring and to dump or deposit collected data on the client machine (e.g., see FIG. 1).

It is noted that although the above and other portions of example embodiments within this text describe code portions with reference to Java™, any other suitable programming language may also be used.

Hereinafter example embodiments including methods of capturing web-page information are described in detail.

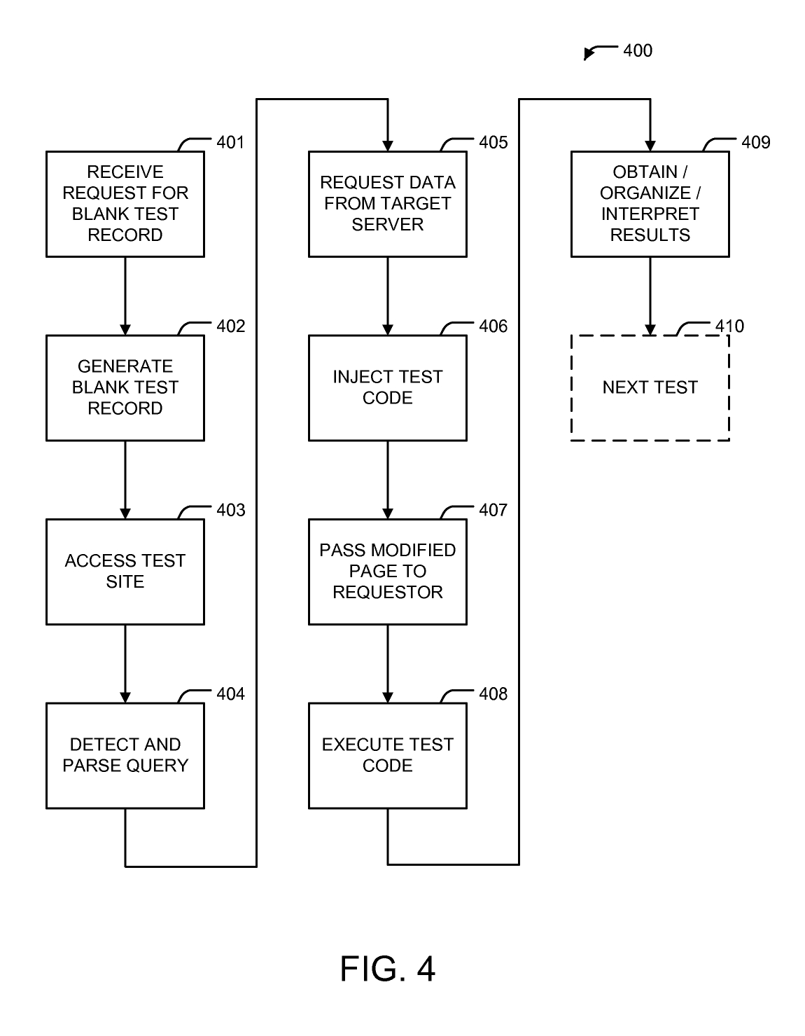

FIG. 4 depicts a method 400 of capturing web-page information through a web-browser plug-in according to example embodiments. The method 400 may include receiving a request for a blank test record at block 401.

For example, receiving the request for the blank test record may include a user of a client machine requesting a blank test record from a data warehouse for a specific web-page. The user may request may identify the webpage using a URL or other suitable identifier/address.

The method 400 may further include generating the blank test record at block 402. For example, the blank test record may be generated at a data warehouse. The test record may include responses containing the requested URL and a test number or ID. The blank test record may be populated with results of any testing performed, as described herein.

The method 400 may further include browsing or accessing the test site or web-page (i.e., “test URL”) at block 403. Browsing or accessing may include accessing the test site through a proxy server/repository.

The method 400 may further include detecting and parsing the query at block 404. For example, the query may be an access request from a client machine transmitted to the proxy server denoting information or webpage information to be retrieved. It is noted that this is optional, and may be omitted, as accessing the test site may comprise identification of the test site, and as a default the entire webpage may be requested below.

The method 400 may further include requesting data from the target web-server at block 405. The data may include webpage data specific to a webpage desired to be tested (i.e. “test site”). This data may be received in response to the requesting, or alternatively, may be retrieved through loading of the test site onto the proxy server.

The method 400 may further include injecting test code portions to the received target web-page data at block 406 to create a modified webpage. The test code may be injected at a proxy server/repository and may include actual testing code, test results submission code, and/or forwarding code. The test code may be configured to measure the CPU hit and memory footprint of web-pages as the web-pages render on the client's browser. The test code may be further configured to allow review screen shots of the webpage/target webpage while the webpage renders. The test code may be further configured to review the rendered HTML on each point of the webpage's lifecycle. The test code may be further configured to measure and show estimates of the time it takes to render each section of the webpage at different connection speeds. The test code may be further configured to validate the content of the webpage against a set of proven “best practice” rules of web development. The test code may be further configured to allow review of downloaded files and depict download time estimation for different connection bandwidths. The test code may be further configured to profile and measure the time it takes to display the webpage. The test code may be further configured to measure the behavior of the webpage when it reaches the tester/user's web browser. The test code may be further configured to validate the webpage's source code against a set of common best-practices. The test code may be further configured to retrieve webpage-specific tips that may aid in increasing a time it takes to display the webpage.

It should be understood and readily apparent to one of ordinary skill in the art that different test code forms may be employed to achieve the configurations described above. For example, test code configured to measure the CPU hit and memory footprint of web-pages as the web-pages render on the client's browser may include algorithms and setting necessary to access and obtain CPU processing statistics and memory statistics during a timeframe in which the webpage is rendering. Such may include code portions directed to reading a processors status, and to reading a memory's status of the client machine on which the webpage is being rendered. A plurality of different algorithms may be employed to calculate the statistics, however raw statistical performance information may also be used and analyzed upon completion of testing.

Test code configured to allow review screen shots of the webpage/target webpage while the webpage renders may include algorithms and settings necessary to retrieve screen shots through a video portion or control of the client machine during a timeframe in which the webpage is rendering. The test code may be configured to retrieve screenshots at predetermined time intervals, rendering completeness percentages (i.e., 25% loaded, 50% loaded, etc.). The test code may also be configured to present screen shots either before, during, or after testing is completed. A plurality of different algorithms or control methodologies may be used to complete these testing actions.

Test code configured to review the rendered HTML on each point of the webpage's lifecycle may include algorithms and settings necessary to retrieve HTML statistics at the client machine during a timeframe in which the webpage is rendering. The test code may be configured to retrieve compiled or decompiled HTML of the webpage and provide statistics on the lifecycle or operating cycle of the webpage. A plurality of different algorithms or control methodologies may be used to complete these testing actions.

Test code configured to measure and show estimates of the time it takes to render each section of the webpage at different connection speeds may include algorithms and settings necessary to determine estimates of rendering times for different portions of the webpage during a timeframe in which the webpage is rendering. The estimates may be based on logical sizes of the desired portions of the webpage to be tested and an associated connection speed. Actual rendering times may also be retrieved for comparison to estimates after testing concludes. A plurality of different algorithms or control methodologies may be used to complete these testing actions.

Test code configured to validate the content of the webpage against a set of proven “best practice” rules of web development may include algorithms and settings necessary to access the set of proven rules or design rules, and compare said rules against the content of the webpage. The content may be compared as styling of HTML code, styling of XML code, webpage organization, and/or any other suitable parameters. A plurality of different algorithms or control methodologies may be used to complete these testing actions.

Test code configured to allow review of downloaded files and depict download time estimation for different connection bandwidths may include algorithms and settings necessary to retrieve downloaded files through a storage portion or control of the client machine during a timeframe in which the webpage is rendering. The test code may be configured to estimate download time frames based on connections speeds and may be configured to retrieve actual download times as well. A plurality of different algorithms or control methodologies may be used to complete these testing actions.

Test code configured to profile and measure the time it takes to display the webpage may include algorithms and settings necessary to retrieve information related to total time expired after successful loading or rendering of the webpage. A plurality of different algorithms or control methodologies may be used to complete these testing actions.

Test code configured to measure the behavior of the webpage when it reaches the tester/user's web browser may include algorithms and settings necessary to retrieve real-time behavioral statistics about the webpage upon receipt, during, and after rendering on the client machine. A plurality of different algorithms or control methodologies may be used to complete these testing actions.

Test code configured to validate the webpage's source code against a set of common best-practices may include algorithms and settings necessary to access the set of best-practices or design rules, and compare said best-practices against the source code of the webpage. The source code may include HTML code, XML code, and/or any other suitable source code incorporated or contained in the webpage. A plurality of different algorithms or control methodologies may be used to complete these testing actions.

Test code configured to retrieve webpage-specific tips that may aid in increasing a time it takes to display the webpage may include algorithms and settings necessary to retrieve a set of tips based on the content of the webpage. The test code may be configured to interpret the content of a webpage (i.e., video-specific, picture-specific, web-blog, etc) and retrieve a set of design tips related to the content. A plurality of different algorithms or control methodologies may be used to complete these testing actions.

Turning back to FIG. 4, the method 400 may further include passing the modified web-page to the requesting client at block 407. For example, the modified webpage may be the target webpage with the test code injected therein. The modified webpage may be passed to the client machine from the proxy server/repository

The method 400 may further include executing the injected test code from the received modified webpage at block 408. The modified webpage may be received at the client machine. Executing may include executing the injected test code at a browser plug-in, as described above. For example, the injected test code may be executed at a computer processor during loading or browsing of the modified webpage. As the modified webpage loads onto a client's browser (which includes the browser plug-in), a set of results may be obtained sequentially, in parallel, or in different combinations of the two during the actual loading of the modified webpage. Depending upon the test code, different statistics and/or measurements associated with the webpage may be obtained. A descriptive listing of test code configuration sis provided above.

The method 400 may further include obtaining, organizing, and/or interpreting results of the executing at block 409 as testing results. The testing results may be displayed, stored, and/or analyzed on a client machine. The test results and statistics for the tested web-page may be used to further enhance the web-page or alter the web-page to increase its performance, decrease rendering times, etc.

The method 400 may further include (optionally) proceeding to the next web-page to be tested at block 410.

As described above, the technical effects and utility of the above-described profiling system and methods, including those features included in the several figures, include the ability to extract additional and supplemental information related to statistics about a particular web-page including processing time or other similar information. Further, the profiling system may provide this information to a developer, and allow altering of a web-page based on the received information such that a more effective web-page may be developed.

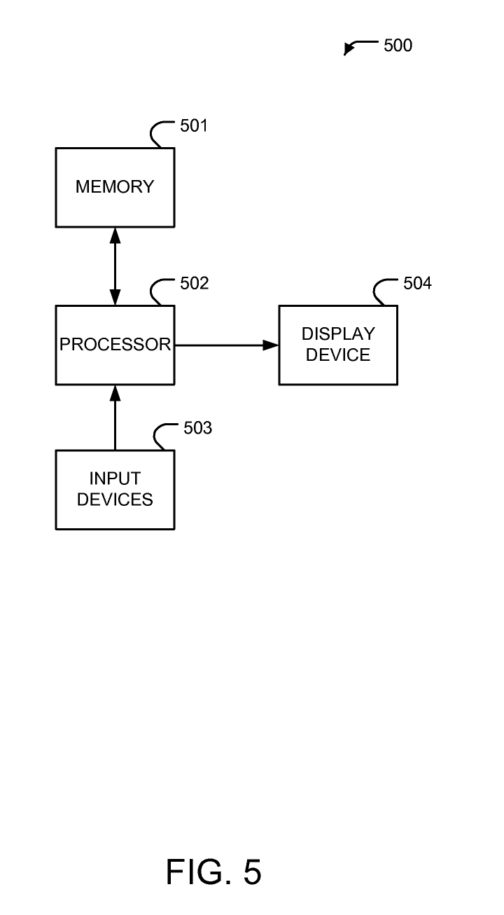

Furthermore, according to an example embodiment, the methodologies described hereinbefore may be implemented by a computer system or apparatus. For example, FIG. 5 illustrates a computer apparatus, according to an exemplary embodiment. Therefore, portions or the entirety of the methodologies described herein may be executed as instructions in a processor 502 of the computer system 500. The computer system 500 includes memory 501 for storage of instructions and information, input device(s) 503 for computer communication, and display device 504. Thus, the present invention may be implemented, in software, for example, as any suitable computer program on a computer system somewhat similar to computer system 500. For example, a program in accordance with the present invention may be a computer program product causing a computer to execute the example methods described herein.

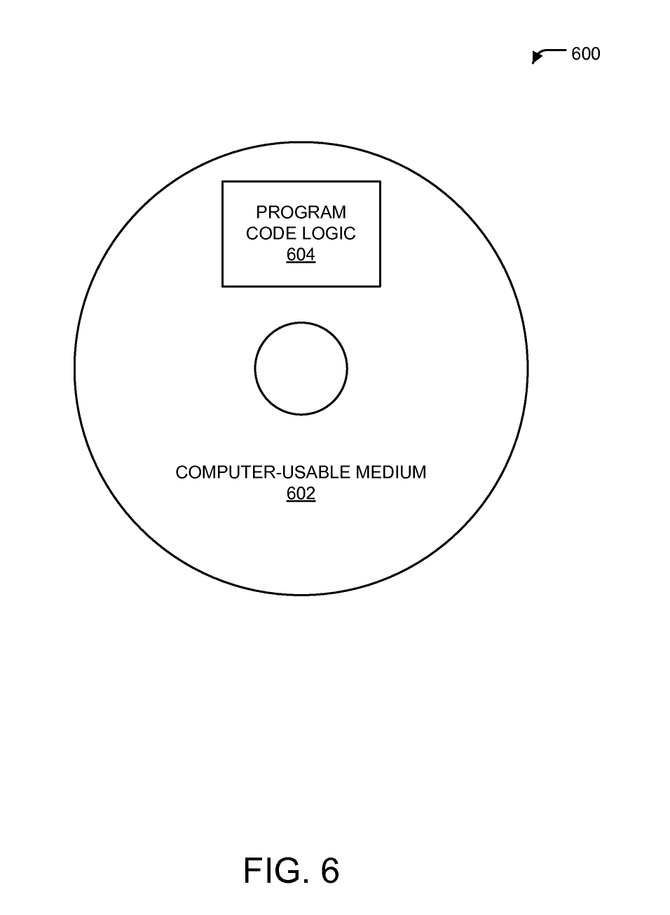

Thus, example embodiments may include a computer program product 600 as depicted in FIG. 6 on a computer usable medium 602 with computer program code logic 604 containing instructions embodied in tangible media as an article of manufacture. Exemplary articles of manufacture for computer usable medium 602 may include floppy diskettes, CD-ROMs, hard drives, universal serial bus (USB) flash drives, or any other computer-readable storage medium, wherein, when the computer program code logic 604 is loaded into and executed by a computer, the computer becomes an apparatus for practicing the invention. Embodiments include computer program code logic 604, for example, whether stored in a storage medium, loaded into and/or executed by a computer, or transmitted over some transmission medium, such as over electrical wiring or cabling, through fiber optics, or via electromagnetic radiation, wherein, when the computer program code logic 604 is loaded into and executed by a computer, the computer becomes an apparatus for practicing the invention. When implemented on a general-purpose microprocessor (e.g., 502), the computer program code logic 604 segments configure the microprocessor to create specific logic circuits.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an exemplary embodiment of the present invention.

Therefore, the methodologies and systems of example embodiments of the present invention can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of at least one example embodiment of the present invention in which functions may be executed out of order from that shown or discussed, including substantially concurrently or in reverse order, depending on the functionality involved, as would be understood by those reasonably skilled in the art of the present invention.

Any program which would implement functions or acts noted in the figures, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for capturing web-page information through a web-browser plug-in, comprising:
a data warehouse;
a client machine in communication with the data warehouse; and
a proxy server in communication with the client machine;
wherein the proxy server is configured to perform a method, comprising,
accessing a target test website,
receiving webpage data from the target website,
injecting test code into the webpage data to create a modified webpage, and
passing the modified webpage to the client machine; and
wherein the client machine is configured to perform a method, comprising,
executing the injected test code from the modified webpage, and
outputting results of the executing.

2. The system of claim 1, wherein the data warehouse is a computer server configured to host previously gathered webpage information.

3. The system of claim 1, further comprising an automation server in communication with the client machine, the automation server configured and disposed to provide automation scripts to the client machine.

4. The system of claim 3, wherein the automation scripts include computer executable code that, when executed on the client machine, direct the client machine to execute a sequence of testing operations on the modified webpage.

5. The system of claim 1, further comprising a target web server in communication with the proxy server, the target web server being a computer server configured and disposed to server the target test website.

6. A computer-implemented method of capturing web-page information through a web-browser plug-in, comprising:
accessing a target test website;
receiving webpage data from the target test website;
injecting test code into the webpage data to create a modified webpage;
executing the injected test code from the modified webpage; and
outputting results of the executing.

7. The method of claim 6, wherein accessing a target test website includes submitting an address or identifier for the target test website to a proxy server, and requesting the webpage data from the target test website.

8. The method of claim 6, further comprising:
receiving a request for a blank test record; and
generating the blank test record.

9. The method of claim 8, wherein the blank test record includes an address or identifier for the target website.

10. The method of claim 9, wherein accessing the target test website includes submitting the blank test record to a proxy server, and requesting the webpage data from the target test website identified through the blank test record.

11. The method of claim 8, wherein outputting the results includes populating the blank test record with the results of the executing.

12. The method of claim 6, wherein receiving webpage data from the target test website includes receiving data and content for the target test website, the data including source code which represents a webpage presenting the content.

13. The method of claim 12, wherein injecting test code includes injecting test algorithms into the source code of the webpage data.

14. The method of claim 13, wherein the test algorithms include algorithms configured to perform at least one of:
measuring a computer processor unit's load during rendering of the modified webpage;
measuring a computer memory's load during rendering of the modified webpage;
estimating a time period for rendering a portion of content of the modified webpage based on a speed of a connection to a target web server serving the target test website;
validating the content against a set of design rules;
profiling and measure complete rendering time of the modified webpage; and
validating the source code against a set of design rules.

15. The method of claim 13, wherein the test algorithms include algorithms configured to measure a computer processor unit's load during rendering of the modified webpage, measure a computer memory's load during rendering of the modified webpage, and validate the content against a set of design rules.

16. A computer program product for capturing web-page information through a web-browser plug-in, comprising a tangible storage medium readable by a processing circuit and storing instructions for execution by the processing circuit for performing a method comprising:
accessing a target test website;
receiving webpage data from the target test website;
injecting test code into the webpage data to create a modified webpage;
executing the injected test code from the modified webpage; and
outputting results of the executing.

17. The computer program product of claim 16, wherein accessing a target test website includes submitting an address or identifier for the target test website to a proxy server, and requesting the webpage data from the target test website.

18. The computer program product of claim 16, further comprising:
receiving a request for a blank test record; and
generating the blank test record; wherein outputting the results includes populating the blank test record with the results of the executing.

19. The computer program product of claim 18, wherein the blank test record includes an address or identifier for the target website, and wherein accessing the target test website includes submitting the blank test record to a proxy server, and requesting the webpage data from the target test website identified through the blank test record.

20. The computer program product of claim 16, wherein receiving webpage data from the target test website includes receiving data and content for the target test website, the data including source code which represents a webpage presenting the content.

21. The computer program product of claim 20, wherein injecting test code includes injecting test algorithms into the source code of the webpage data.

22. The computer program product of claim 21 wherein the test algorithms include algorithms configured to perform at least one of:
measuring a computer processor unit's load during rendering of the modified webpage;
measuring a computer memory's load during rendering of the modified webpage;
estimating a time period for rendering a portion of content of the modified webpage based on a speed of a connection to a target web server serving the target test website;
validating the content against a set of design rules;
profiling and measure complete rendering time of the modified webpage; and
validating the source code against a set of design rules.
